(19) United States
(12) Patent Application Publication
(10) Pub. No.: US 2016/0221455 A1
(43) Pub. Date: Aug. 4, 2016

(54) CHARGING SYSTEM OF IN-VEHICLE BATTERY AND CHARGING METHOD OF IN-VEHICLE BATTERY

(71) Applicant: TOYOTA JIDOSHA KABUSHIKI KAISHA, Toyota-shi, Aichi-ken (JP)

(72) Inventors: Hiroya ANDO, Toyota-shi (JP); Kengo HAYASHIZAKI, Okazaki-shi (JP); Yukihiro MIYASHITA, Yokkaichi-shi (JP); Yoshifumi OHMORI, Toyota-shi (JP)

(73) Assignee: TOYOTA JIDOSHA KABUSHIKI KAISHA, Toyota-shi, Aichi-ken (JP)

(21) Appl. No.: 15/021,207

(22) PCT Filed: Sep. 8, 2014
(86) PCT No.: PCT/IB2014/001757

§ 371 Date: Mar. 10, 2016

(30) Foreign Application Priority Data
Sep. 11, 2013 (JP) 2013-187985

(51) Int. Cl. B60L 11/18

(52) U.S. Cl. CPC B60L 11/185; B60L 11/1861

(57) ABSTRACT

A charging system of an in-vehicle battery (11) is configured to charge the in-vehicle battery with an external charging device (30) capable of performing quick charging. The charging system includes a rainfall information acquiring unit and a controller (15). The rainfall information acquiring unit is configured to acquire rainfall information that is information indicating whether it is raining. The controller is configured to control a charging mode of the in-vehicle battery with the external charging device. Furthermore, the controller is configured to inhibit performing of the quick charging or to reduce an amount of charging current in the quick charging based on the rainfall information, which indicates that it is raining, acquired by the rainfall information acquiring unit.

### BACKGROUND OF THE INVENTION

1. Field of the Invention

The present invention relates to a charging system of an in-vehicle battery and a charging method of an in-vehicle battery.

2. Description of Related Art

With the recent spread of electric vehicles and plug-in hybrid vehicles, infrastructure such as charging stands for charging an in-vehicle battery has been organized. Charging modes of an in-vehicle battery can currently be classified into a normal charging mode in which the in-vehicle battery is charged with AC power sources of 100 V, 200 V, and the like and a quick charging mode in which the in-vehicle battery is charged with DC high-voltage power sources of 50 kW and the like. Among these charging modes, the quick charging mode has a merit that the charging time is shorter than that in the normal charging mode, but since a large current flows in a charging cable, a plurality of measures for safety is normally employed.

For example, Japanese Patent Application Publication No. 2005-312224 (JP 2005-312224 A) proposes a device that calculates an amount of electricity charged during the quick charging as an accumulated value of a current and that stops the quick charging when the accumulated value is equal to or greater than a limit value, in order to suppress an excessive rise in temperature of a battery liquid, a transformer, a rectifying portion, and the like even in the quick charging.

In the device described in JP 2005-312224 A, the excessive rise in temperature of the battery liquid, the transformer, the rectifying portion, and the like can be suppressed, but, for example, the possibility of electric leakage accompanied with a problem in a charging cable or a connector is not considered. Accordingly, there is room for improvement in consideration of measures for electric leakage in the quick charging.

### SUMMARY OF THE INVENTION

The present invention provides a charging system of an in-vehicle battery and a charging method of an in-vehicle battery that can enhance safety in charging the in-vehicle battery with an external charging device capable of performing quick charging.

A charging system of an in-vehicle battery according to a first aspect of the invention is configured to charge the in-vehicle battery with an external charging device capable of performing quick charging. The charging system of the in-vehicle battery according to the first aspect of the invention includes a rainfall information acquiring unit and a controller. The rainfall information acquiring unit is configured to acquire rainfall information that is information indicating whether it is raining. The controller is configured to control a charging mode of the in-vehicle battery with the external charging device. The controller is configured to inhibit performing of the quick charging or to reduce an amount of charging current in the quick charging based on the rainfall information, which indicates that it is raining, acquired by the rainfall information acquiring unit.

A charging method of an in-vehicle battery according to a second aspect of the invention is a charging method of charging the in-vehicle battery with an external charging device capable of performing quick charging. The charging method includes: causing a rainfall information acquiring unit to acquire rainfall information that is information indicating whether it is raining; causing a controller to control a charging mode of the in-vehicle battery with the external charging device; and inhibiting the performing of the quick charging or reducing an amount of charging current in the quick charging based on the rainfall information, which indicates that it is raining, acquired by the rainfall information acquiring unit at a time of controlling the charging mode.

According to the first and second aspects of the invention, the performing of the quick charging is inhibited or the amount of charging current in the quick charging is reduced under the condition that the information indicating that it is raining is acquired. When the performing of the quick charging is inhibited, it is possible to prevent electric leakage due to the wetting of a charging cable or a connector having a problem. On the other hand, when the amount of charging current is reduced, it is possible to enhance the measures for electric leakage without greatly damaging convenience for a user. Accordingly, it is possible to enhance safety in charging the in-vehicle battery.

In the first aspect of the invention, the controller may be configured to select he quick charging and normal charging, which is charging using an AC current, of the in-vehicle battery. The controller may be configured to select the normal charging based on the rainfall information, which indicates that it is raining, acquired by the rainfall information acquiring unit.

According to this configuration, the control when the information indicating that it is raining is acquired includes selecting the normal charging with an AC current. Accordingly, the charging of the in-vehicle battery is not inhibited. As a result, it is possible to enhance the measures for electric leakage without greatly damaging convenience for a user.

In the first aspect of the invention, the controller may be configured to acquire a state of charge of the in-vehicle battery and to predict, based on the acquired state of charge, a charging end time when the normal charging is selected. The controller may be configured to select the normal charging under a condition that the predicted charging end time is equal to or less than a desired charging end time set by a user.

According to this configuration, when the charging end time is equal to or less than the desired charging end time, the normal charging is selected. Accordingly, it is possible to perform minimum measures for electric leakage without greatly damaging convenience for a user.

In the first aspect of the invention, the controller may be configured to acquire a state of charge of the in-vehicle battery and to predict a charging end time when the normal charging is selected based on the acquired state of charge. The controller may be configured to perform the quick charging with the reduced amount of charging current under a condition that the predicted charging end time is greater than a desired charging end time set by a user.

According to this configuration, when the predicted charging end time is greater than the desired charging end time, the quick charging with the reduced amount of charging current is performed. Accordingly, it is possible to appropriately cause the convenience based on the quick charging and the enhancement of the measures for electric leakage to be compatible with each other.

In the first aspect of the invention, the rainfall information acquiring unit may be a rain sensor mounted on a vehicle and configured to detect whether it is raining based on wetting of the vehicle. According to this configuration, it is determined by the rain sensor mounted on a vehicle body for controlling of a wiper whether it is raining. Accordingly, even when the vehicle body is wet for reasons other than rain, such as a car wash, as well as rainfall or snowfall, it is possible to detect wetting of the vehicle in real time. An existing sensor may be effectively used without providing a new particular sensor as measures for electric leakage.

In the first aspect of the invention, the rainfall information acquiring unit may be configured to acquire weather information of an area in which the external charging device is installed. According to this configuration, it can be determined whether it is raining, as long as a device that can receive information from facilities providing weather information is provided. The rainfall information acquiring unit may be disposed in any of the vehicle and the external charging device.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG 1 is a block diagram schematically illustrating a configuration of a vehicle and an external charging device in a first embodiment of a charging system of an in-vehicle battery and a charging method of an in-vehicle battery according to the invention;

FIG. 2 is a flowchart illustrating a charging operation in the first embodiment;

FIG. 3 is a flowchart illustrating a charging operation in a second embodiment of a charging system of an in-vehicle battery and a charging method of an in-vehicle battery according to the invention;

FIG. 4 is a flowchart illustrating a charging operation in a third embodiment of a charging system of an in-vehicle battery and a charging method of an in-vehicle battery according to the invention;

FIG. 5 is a block diagram schematically illustrating a configuration of a vehicle and an external charging device in a fourth embodiment of a charging system of an in-vehicle battery and a charging method of an in-vehicle battery according to the invention;

FIG. 6 is a flowchart illustrating a charging operation in the fourth embodiment;

FIG. 7 is a block diagram schematically illustrating a configuration of a vehicle and an external charging device in a fifth embodiment of a charging system of an in-vehicle battery and a charging method of an in-vehicle battery according to the invention; and

FIG. 8 is a block diagram schematically illustrating a configuration of a vehicle and an external charging device in a modification example of a charging system of an in-vehicle battery and a charging method of an in-vehicle battery according to the invention.

### DETAILED DESCRIPTION OF EMBODIMENTS

### First Embodiment

Hereinafter, a first embodiment of a charging system of an in-vehicle battery and a charging method of an in-vehicle battery will be described below In this embodiment, an electric vehicle in which an in-vehicle battery is charged with an external charging device such as a charging stand will be exemplified as a vehicle on which the in-vehicle battery is mounted.

As illustrated in FIG. I. a vehicle 100 includes a drive battery 11 that is a drive source of a running motor (not illustrated). The drive battery 11 is a known battery of several hundreds of volts and is constituted, for example, by a lithium ion secondary battery.

The drive battery 11 is connected to a charging controller 12 via a charging power supply line 24. The charging controller 12 is a device that controls a charging mode of the drive battery 11 in cooperation with a charging controller 32 on the external charging device 30 side. Particularly, in this embodiment, cable groups 23, 33 connected to a vehicle-side connector 21 and a connector 31 on the external charging device 30 side include a quick-charging cable, a normal-charging cable, and a communication line used for communication between the charging controller 12 and the charging controller 32. The quick charging and the normal charging using the dedicated cables can be switched by communication between the charging controllers 12, 32. Here, the quick charging means charging with a DC current and the normal charging means charging with an AC current.

In this embodiment, the vehicle 100 is provided with a rain sensor 20 that detects attachment of raindrops to a front window or the like for the purpose of wiper control or the like. The rain sensor 20 outputs a detection signal (rainfall information) indicating whether it is raining to a charging-control electronic control unit (ECU) 15. The ECU 15 outputs a control command to the charging controller 12 on the basis of the rainfall information. The ECU 15 is also a device that monitors a state of charge (SOC) of the drive battery 11 through the use of the charging controller 12. The charging controller 12, the rain sensor 20, and the ECU 15 operate with a supply of power from an auxiliary battery 13 similarly mounted on the vehicle 100.

A charging operation in this embodiment that is performed in cooperation with the vehicle 100 and the external charging device 30 will be described below. In the charging system, the quick charging is selected as standard charging.

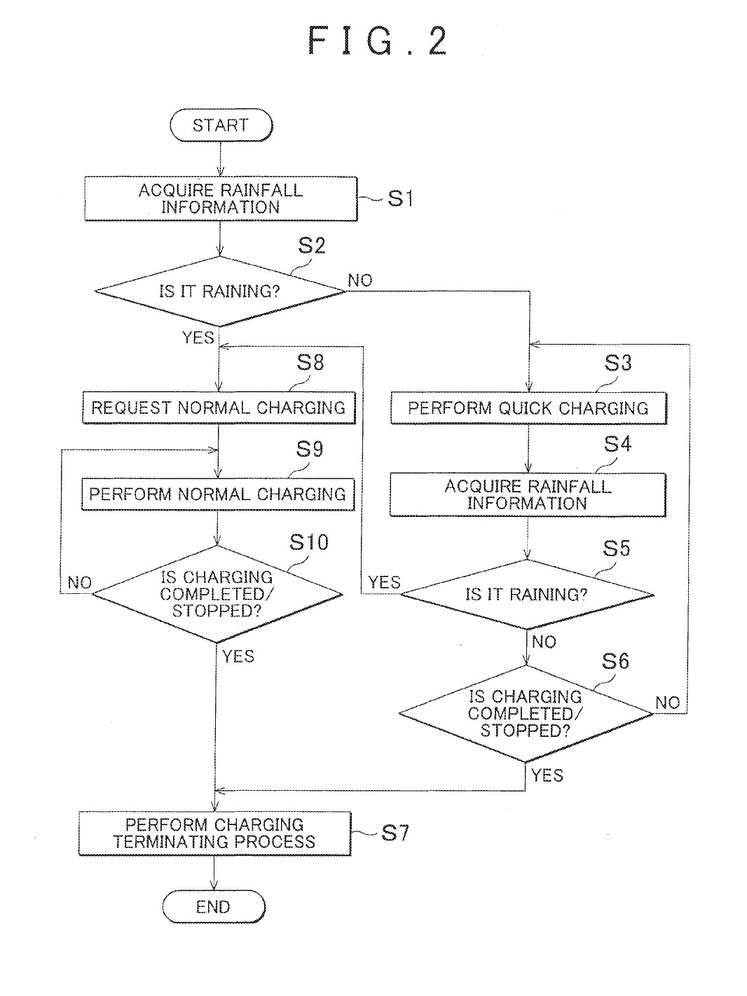

As illustrated in FIG. 2, the ECU 15 acquires rainfall information under the condition that the vehicle-side connector 21 and the external connector 31 are connected to each other (step S1). Subsequently, the ECU 15 determines whether it is raining on the basis of the rainfall information (step S2). Here, the rainfall information from the rain sensor 20 includes a detected amount of raindrops (amount of rainfall). Accordingly, at the time of determination, the ECU 15 determines that “it is raining” when the amount of raindrops is greater than a predetermined value. Here, the case where it is determined that “it is raining” includes a case where it is snowing or raining and a case where the vehicle body is wet for reasons other than rain, such as a car wash.

When the ECU 15 determines that it is not raining (NO in step S2), the ECU 15 commands the charging controllers 12, 32 to start the quick charging as the standard charging. Accordingly, the quick charging is started (step S3).

During the quick charging, the ECU 15 acquires the rainfall information similarly to step S2 (step S4) and continues to determine whether it is raining (step S5). When it is determined that the charging is completed or the stop of the charging due to disconnection of the vehicle-side connector 21 and the external connector 31 or the like is detected in the state where it is determined that it is not raining (NO in step S5), the ECU 15 performs a charging terminating process of commanding, the charging controller 12 to terminate the charging (step S7) and terminates a series of charging operations.

On the other hand, when it is determined that it is raining before the quick charging or during the quick charging (YES in step S2 or S5), the ECU 15 transmits a normal charging request to the charging controller 32 of the external charging device 30 and the charging controller 12 via the communication lines of the cable groups 23, 33 (step S8). Accordingly, the charging controller 32 of the external charging device 30 and the charging controller 12 of the vehicle 100 start the normal charging using an AC current via the normal-charging cable (step S9). Similarly to step S6, when it is determined that the charging is completed or the charging is stopped (YES in step S10), the charging terminating process is performed (step S7) and a series of charging operations is terminated.

As described above, the charging system of an in-vehicle battery and the charging method of an in-vehicle battery according to this embodiment can achieve the following advantages. (1) When the information indicating that it is raining is transmitted on the basis of the rainfall information acquired through the use of the rain sensor 20 by the ECU 15 of the vehicle 100, the charging mode is switched so as to select the normal charging instead of the quick charging. Accordingly, even when it is raining, it is possible to enhance measures for electric leakage without greatly damaging convenience for a user at the time of charging. As a result, it is possible to enhance safety in the charging operation of the drive battery 11.

(2) In this embodiment, it is determined whether it is raining through the use of the rain sensor 20 disposed in the vehicle body. Accordingly, even when the vehicle body is wet for reasons other than rain, such as a car wash, as well as rainfall and snowfall, it is possible to detect that “it is raining”. Since the existing rain sensor 20 provided for wiper control can be effectively used, it is not necessary to newly provide a particular sensor far measures for electric leakage.

### Second Embodiment

A second embodiment of the charging system of an in-vehicle battery and a charging method of an in-vehicle battery will he described below with a focus placed on differences from the first embodiment. The basic configuration of the charging system of an in-vehicle battery according to this embodiment is equal to the system configuration of the first embodiment. Substantially the same elements as in the charging method according to the first embodiment out of the charging method of an in-vehicle battery according to this embodiment will be referenced by the same reference numerals and description thereof will not be repeated.

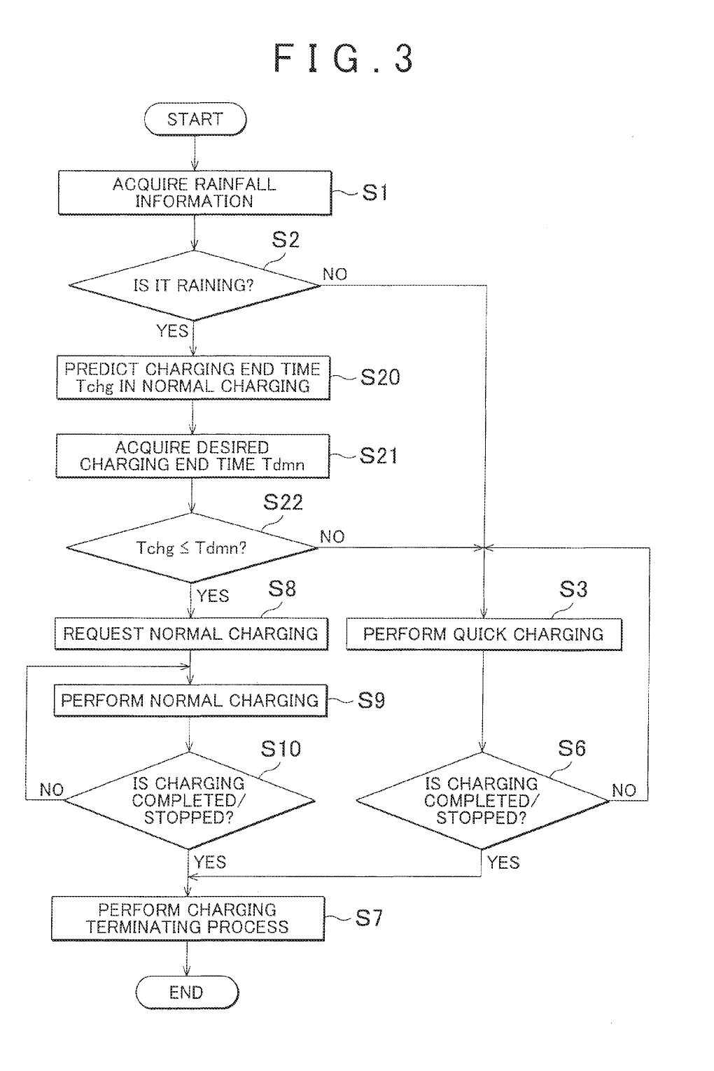

A charging operation of the charging system according to this embodiment will be described below with reference to FIG. 3. In this embodiment, similarly to the first embodiment, the ECU 15 acquires rainfall information (step S1) and determines whether it is raining (step S2). When it is determined that it is not raining (NO in step S2), the ECU 15 starts the quick charging as a standard charging mode (step S3) and then continues to perform the quick charging of the drive battery 11 until it is determined that the charging is completed or the charging is stopped.

On the other hand, when it is determined that it is raining (YES in step S2), the ECU 15 predicts a charging end time Tchg in the normal charging (step S20). At this time, the ECU 15 acquires the state of charge of the drive battery 11 through the use of the charging controller 12 and calculates the time until the state of charge reaches a target value from the state of charge at that time on the basis of the amount of charging current in the normal charging. For example, the target value corresponds to a full state of charge and is set in advance depending on a battery type.

Then, the ECU 15 acquires a desired charging end time Tdmn set by the vehicle 100 side (step S21). The desired charging end time Tdmn is a time that is set in advance in a memory (not illustrated) in the vehicle 100 through the use of an input operation unit on the vehicle 100 side by a user. The ECU 15 compares the calculated charging end time Tchg with the desired charging end time Tdmn and determines whether the charging end time Tchg is equal to or less than the desired charging end time Tdmn (step S22).

When it is determined that the charging end time Tchg is equal to or less than the desired charging end time Tdmn (YES in step S22), the ECU 15 transmits a normal charging request (step S8) and continues to perform the normal charging until it is determined that the charging is completed or the charging is stopped (steps S9, S10).

On the other hand, even when it is determined that the charging end time Tchg is greater than the desired charging end time Tdmn (NO in step S22) but it is determined that it is raining, the ECU 15 performs the quick charging as a kind of exception routine with priority given to the charging (step S3). Until it is determined that the charging is completed or the charging is stopped, the quick charging of the drive battery 11 is continuously performed (steps S3, S6).

As described above, the charging system and method of an in-vehicle battery according to this embodiment can achieve the following advantage addition to the advantages of (1) and (2).

(3) The normal charging is actively selected when the charging end time Tchg is equal to or less than the desired charging end time Tdmn, and it is thus possible to enhance the minimum measures for electric leakage without greatly damaging the convenience for a user.

### Third Embodiment

A third embodiment of the charging system of an in-vehicle battery and a charging method of an in-vehicle battery will be described below with a focus placed on differences from the first embodiment and the second embodiment. The basic configuration of the charging system of an in-vehicle battery according to this embodiment is equal to the system configuration of the first embodiment. Substantially the same elements as in the charging method according to the first embodiment and the second embodiment out of the charging method of an in-vehicle battery according to this embodiment will be referenced by the same reference numerals and description thereof will not be repeated.

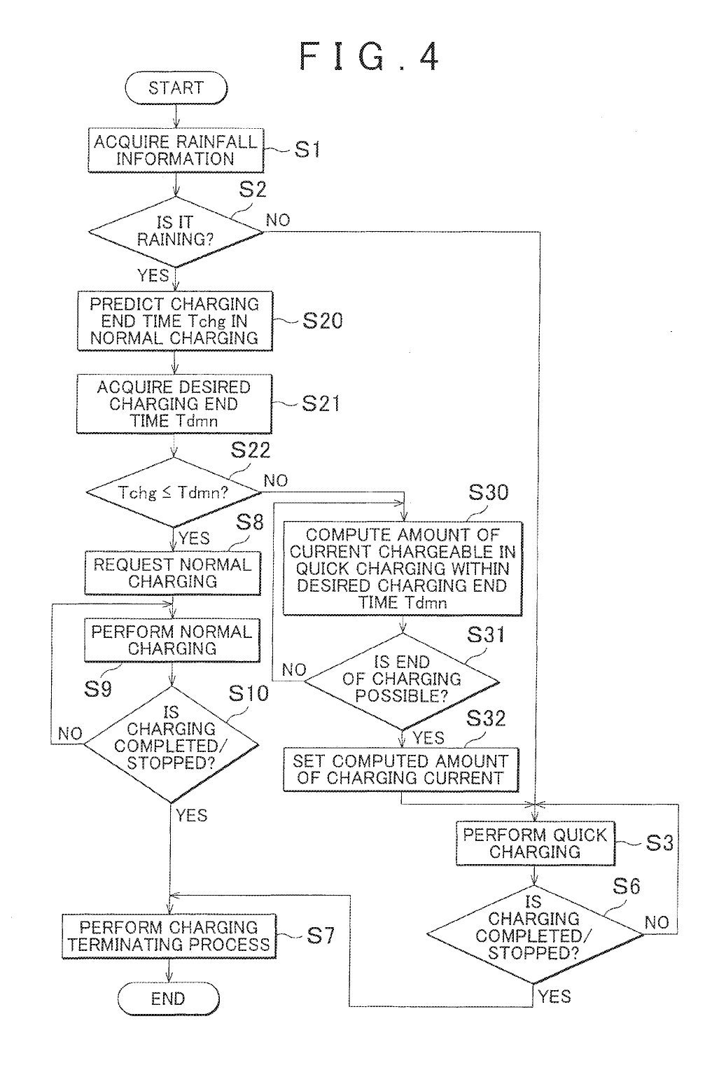

A charging operation of the charging system according to this embodiment will be described below with reference to FIG. 4. In this embodiment, similarly to the first embodiment, the ECU 15 acquires rainfall information (step S1) and determines whether it is raining (step S2). When it is determined that it is not raining (NO in step S2), the ECU 15 starts the quick charging (step S3) and then continues to perform the quick charging of the drive battery 11 until it is determined that the charging is completed or the charging is stopped (steps S3, S6).

On the other hand, when it is determined that it is raining (YES in step S2), the ECU 15 predicts the charging end time Tchg in the normal charging, similarly to the second embodiment (step S20) and acquires the desired charging end time Tdmn set by the vehicle side (step S21). Then, the ECU 15 compares the predicted charging end time Tchg with the desired charging end time Tdmn and determines whether the charging end time Tchg is equal to or less than. the desired charging end time Tdmn (step S22).

When it is determined that the charging end time Tchg is equal to or less than the desired charging end time Tdmn (YES in step S22), the ECU 15 transmits a normal charging request similarly to the second embodiment (step S8) and continues to perform the normal charging of the drive battery 11 until it is determined that the charging is completed or the charging is stopped (steps S9, S10).

On the other hand, when it is determined that the charging end time Tchg is greater than the desired charging end time Tdmn (NO in step S22), the ECU 15 computes an amount of current with which the drive battery can be charged in the quick charging, that is, the charging using a DC current, with a smaller amount of charging current than that in the normal quick charging within the user's desired charging end time Tdmn (step S30). At this time, for example, the ECU 15 subtracts the state of charge (%) at that time from the target value (%) of the state of charge of the drive battery 11, converts the difference into an necessary amount of power, and converts the amount of power into an amount of current to be calculated on the basis of the amount of power and the desired charging end time Tdmn.

The ECU 15 determines whether the drive battery can be charged with the computed amount of current within the desired charging end time Tdmn on the basis of various conditions (step S31). When it is determined in step S31 that the drive battery can be charged, the ECU 15 sets the computed amount of current as the amount of charging current in the quick charging (step S32) and then performs the quick charging (step S3). That is, in this case, the quick charging with a reduced amount of current is performed.

As described above, the charging system and method of an in-vehicle battery according to this embodiment can achieve the following advantage in addition to the advantages of (1) and (2).

(4) The quick charging with a reduced amount of current is performed when the charging end time Tchg is greater than the desired charging end time Tdmn, and it is thus possible to cause the convenience based on the quick charging and the enhancement of the measures for electric leakage to be compatible with each other.

### Fourth Embodiment

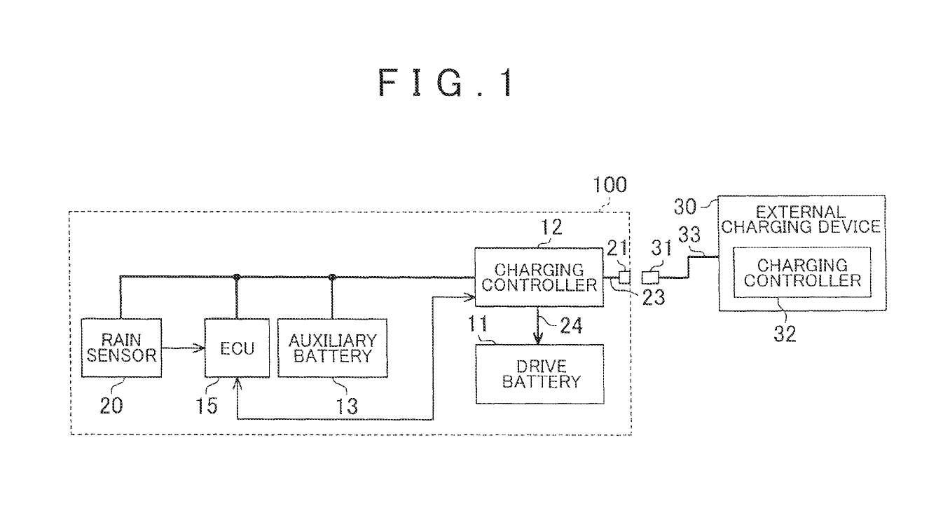

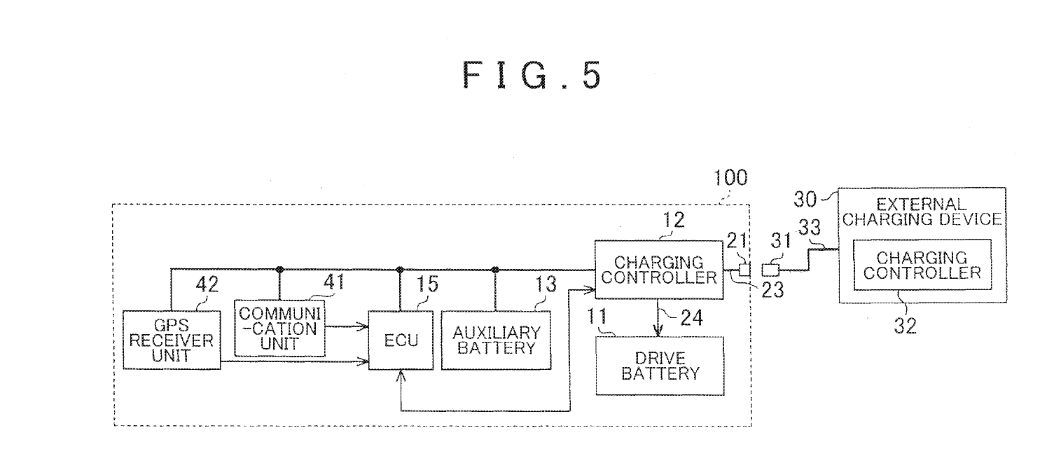

A fourth embodiment of a charging system of an in-vehicle battery and a charging method of an in-vehicle battery will be described below with a focus placed on differences from the first embodiment. The basic configurations of the charging system of an in-vehicle battery and the charging method of an in-vehicle battery according to this embodiment are equal to the configurations of the first embodiment illustrated in FIG. 1. Substantially the same elements in FIG. 5 as in the first embodiment will be referenced by the same reference numerals and description thereof will not be repeated.

As illustrated in FIG. 5, the vehicle 100 includes a device that can receive information from facilities providing weather information. In this embodiment, the device includes a communication unit 41 that performs vehicle information and communication system (VICS: registered trademark) communications. The vehicle 100 includes a UPS receiver unit 42 that detects the position of the vehicle. The VICS information acquired by the communication unit 41 and the information of the vehicle position received from the GPS receiver unit 42, which have been acquired, for example, just before an ignition key is turned off, are stored in a memory or can be acquired by the ECU 15 even after the ignition key is turned off.

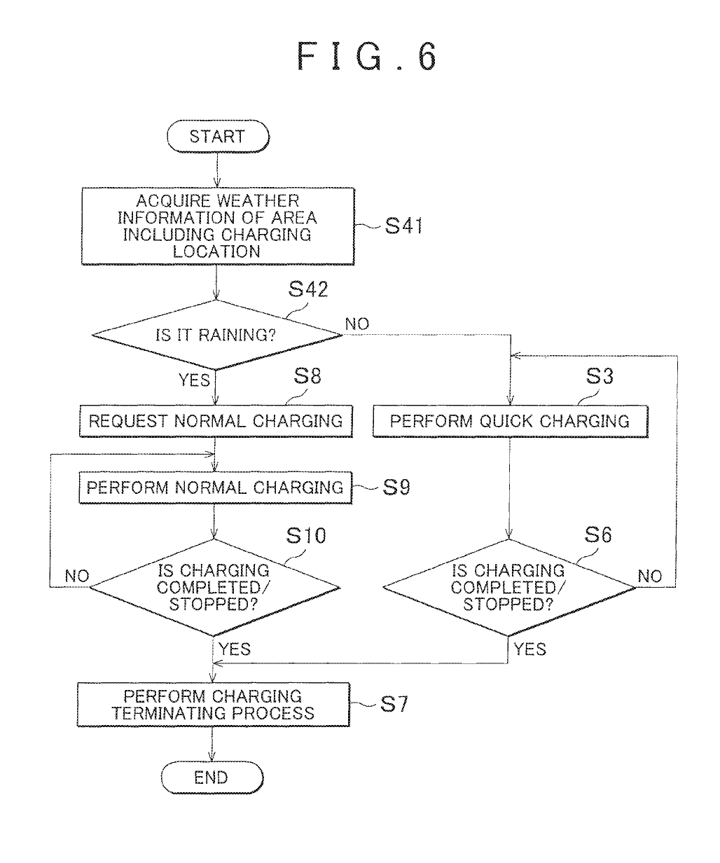

The charging operation of the charging system according to this embodiment will be described below with reference to FIG. 6. The ECU 15 acquires the position information of the vehicle 100, that is, the position information of a charging stand in which the external charging device 30 is placed, and the VICS information including the weather information as the rainfall information under the condition that the vehicle-side connector 21 and the external connector 31 are connected to each other. Furthermore, the ECU 15 acquires the weather information of an area including the charging location (step S41). The ECU 15 determines whether it is raining on the basis of the weather of the time point included in the weather information (step S42). For example, it is determined that it is raining when the weather of the area is rainy or snowy, and it is determined that it is not raining when the weather is fair or cloudy.

When it is determined that it is not raining (NO in step S42), the ECU 15 performs the quick charging until it is determined that the charging is completed or the charging is stopped (steps S3, S6). Here, the weather information is not checked during the quick charging, and the reason thereof is that the update cycle of the weather information is generally longer than the time required for the quick charging.

On the other hand, when it is determined that it is raining on the basis of the weather information (YES in step S2), the ECU 15 transmits a normal charging request (step S8) and continues to perform the normal charging until the charging is completed or the charging is stopped (steps S9, S10).

As described above, the charging system and method of an in-vehicle battery according to this embodiment can achieve the following advantages. (5) When the information indicating that it is raining is transmitted on the basis of the weather information acquired through the use of the communication unit 41, the charging mode is switched so as to perform the normal charging instead of the quick charging. Accordingly, even when it is raining, it is possible to enhance the measures for electric leakage without greatly damaging convenience for a user. As a result, it is possible to enhance safety in the charging operation of the drive battery 11.

(6) Since the existing communication unit 41 or the GPS receiver unit 42, which are often mounted on a vehicle as a standard in recent years, can be effectively used, it is not necessary to newly provide a particular sensor for the measures of electric leakage.

### Fifth Embodiment

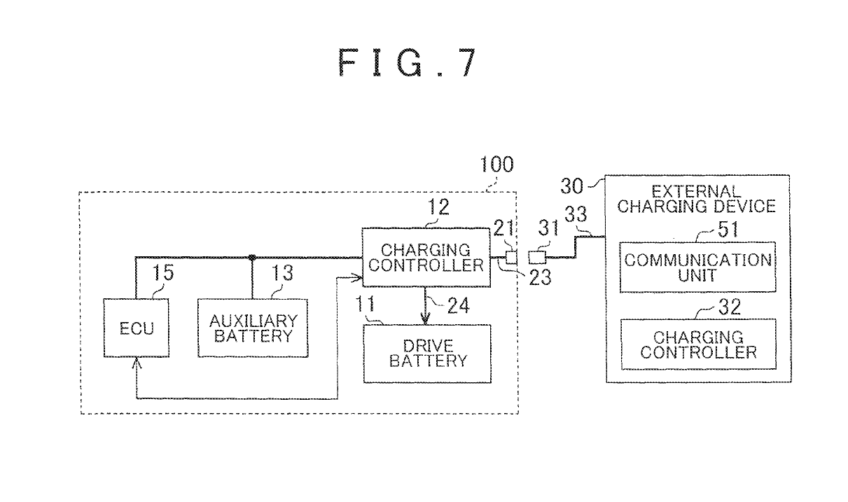

A fifth embodiment of a charging system of an in-vehicle battery and a charging method of an in-vehicle battery will be described below with a focus placed on differences from the first embodiment and the fourth embodiment. The basic configurations of the charging system of an in-vehicle battery and the charging method of an in-vehicle battery according to this embodiment are equal to the configurations of the first embodiment and the fourth embodiment illustrated in FIG. 1 or 5. Substantially the same elements in FIG. 7 as in the first embodiment and the fourth embodiment will be referenced by the same reference numerals and description thereof will not be repeated.

As illustrated in FIG. 7, the external charging device 30 installed in a charging stand and the like includes a communication unit 51 in addition to the external connector 31, the charging controller 32, and the cable group 33. The communication unit 51 is a device that receives information from facilities providing weather information and, for example, is a unit that performs the VICS communication. A vehicle 100 has a configuration in which the rain sensor 20 is removed from the vehicle 100 according to the first embodiment or the use thereof is skipped.

The charging operation of the charging system according to this embodiment is different from the charging operation of the fourth embodiment illustrated in FIG. 6, in that the acquiring of the weather information in step S41 is performed by the communication unit 51 of the external charging device 30. The charging operations illustrated in FIG. 6 are sequentially performed in such a way that the weather information acquired through the use of the communication unit 51 is fed back from the charging controller 32 of the external charging device 30 to the ECU 15 via the charging controller 12 of the vehicle 100.

As described above, the charging system and the charging method of an in-vehicle battery according to this embodiment can achieve the following advantages. (7) When the information indicating that it is raining is transmitted on the basis of the weather information acquired through the use of the communication unit 51, the charging mode is switched so as to perform the normal charging instead of the quick charging by the ECU 15 to which the information has been fed back from the charging controller 32 of the external charging device 30. Accordingly, even when it is raining, it is possible to enhance the measures for electric leakage without greatly damaging convenience for a user. As a result, it is possible to enhance safety in the charging operation of the drive battery 11.

(8) Since the weather information is acquired by equipment on the side of charging stands that are absolutely smaller than the number of vehicles, it is possible to simplify vehicle-side equipment as a charging system that takes measures for electric leakage for the quick charging.

### Other Embodiments

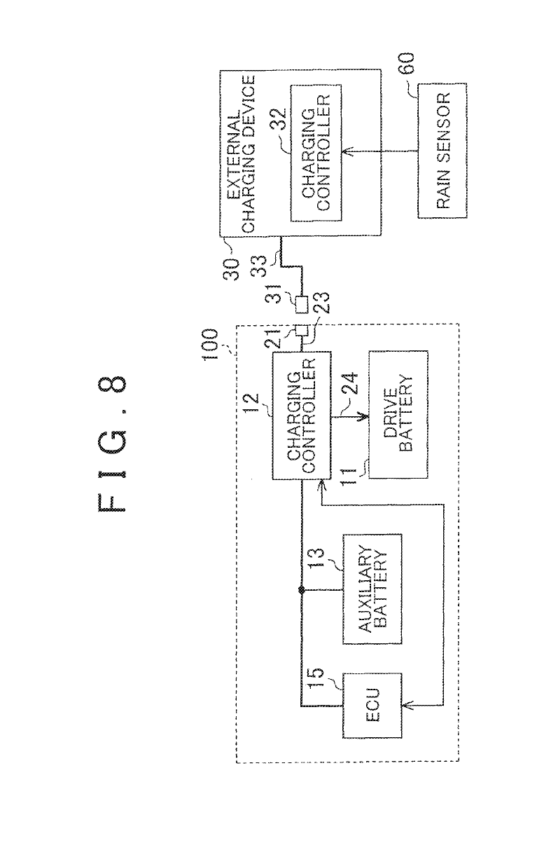

The above-mentioned embodiments may be implemented in the following aspects. As illustrated in FIG. 8, the rain sensor in the first to third embodiments may be connected to the external charging device 30. The rain sensor 60 in this aspect is disposed outdoor and detects an amount of raindrops (amount of rainfall) of a detection area disposed to attach raindrops thereto at the time of raining. The detection result of the rain sensor 60 is fed back to the ECU 15 from the charging controller 32 via the charging controller 12 of the vehicle 100, as described in the fifth embodiment Alternatively, the charging controller 32 may determine whether it is raining on the basis of the rainfall information acquired by the rain sensor 60, may select a charging mode for the drive battery 11, and may request the ECU 15 for the normal charging or the quick charging with a reduced amount of current. This aspect can achieve the advantages similar to the advantages of (7), (8).

In the first embodiment, it is determined even during the quick charging whether it is raining, but the quick charging may continue to be performed without determining whether it is raining until the charging is completed or stopped after the quick charging is determined.

In the third embodiment, the quick charging with a reduced amount of current is selected when the charging end time Tchg is greater than the desired charging end time Tdmn, but the quick charging with a reduced amount of current may be selected without comparing the charging end time Tchg with the desired charging end time Tdmn. That is, immediate when the ECU 15 determines that it is raining, the drive battery 11 may be charged with a DC current with a smaller amount of current than the amount of charging current in the normal quick charging.

In the fourth embodiment, similarly to the second, embodiment, the charging end time Tchg may be compared with the desired charging end time Tdmn when the ECU 15 determines that it is raining, and the normal charging may be selected when the charging end time Tchg is equal to or less than the desired charging end time Tdmn. Alternatively, similarly to the third embodiment, when the charging end time Tchg is greater than the desired charging end time Tdmn, the amount of current with which the drive battery can be charged within the desired charging end time Tdmn may be computed and the quick charging may be performed with the computed amount of charging current.

In the fifth embodiment, similarly to the second embodiment, the charging end time Tchg may be compared with the desired charging end time Tdmn when the ECU 15 to which the weather information has been fed back determines that it is raining, and the normal charging may be selected when the charging end time Tchg is equal to or less than the desired charging end time Tdmn. Alternatively, similarly to the third embodiment, when the charging end time Tchg is greater than the desired charging end time Tdmn, the amount of current with which the drive battery can be charged within the desired charging end time Tdmn may be computed and the quick charging may be performed with the computed amount of charging current.

In the fifth embodiment, the ECU 15 requests for the normal charging when it is determined that it is raining, but the charging controller 32 of the external charging device 30 may request the vehicle 100 for the normal charging.

In the above-mentioned embodiments, the external charging device 30 and the ECU 15 of the vehicle 100 transmit and receive various signals via the communication lines of the cable groups 23, 33, but may transmit and receive various signals therebetween by wireless communication.

In the above-mentioned embodiments, the quick charging is set as a standard charging mode, the ECU 15 selects the normal charging or the quick charging, and the charging is automatically performed in the selected mode. Instead, after the normal charging is selected, availability of the normal charging or the quick charging with a reduced amount of current may be displayed on a display (not illustrated) disposed in the external charging device 30 so as to cause a user to allow the charging. The charging is performed when a user operates the display so as to allow the normal charging or the quick charging with a reduced amount of current, and the charging may be stopped when the user operates the display so as to inhibit the normal charging or the quick charging with a reduced amount of current. Alternatively, the ECU 15 or the charging controller 32 may transmit an E-mail or the like inquiring about whether the normal charging or the quick charging with a reduced amount of current should he allowed to a portable terminal having a communication function, which is carried by the user. When a notification for allowing the charging based on the user's operation is received, the charging controller 32 starts the normal charging or the quick charging with a reduced amount of current. According to this configuration, it is possible to cause a user to confirm the intention and it is thus possible to enable the charging based on the user's intention.

In the above-mentioned embodiments, the vehicle 100 includes the auxiliary battery 13 in addition to the drive battery 11, but a configuration in which power is supplied to a running motor and various controllers by only the drive battery 11 or a voltage controller may be employed.

In the above-mentioned embodiment, the charging system of an in-vehicle battery is exemplified as a system for charging an electric vehicle, but may be used as a system for charging other types of vehicles. For example, a plug-in hybrid vehicle that runs using a running motor and an engine in parallel may be used as the charging target.

1. A charging system of an in-vehicle battery configured to charge the in-vehicle battery with an external charging device capable of performing quick charging, the charging system comprising:
a rainfall information acquiring unit configured to acquire rainfall information that is information indicating whether water falls; and
a controller configured to control a charging mode of the in-vehicle battery with the external charging device,
wherein the controller is configured to inhibit performing of the quick charging or to reduce an amount of charging current in the quick charging based on the rainfall information, which indicates that water falls, acquired by the rainfall information acquiring unit.

2. The charging system of the in-vehicle battery according to claim 1, wherein the controller is configured to select the quick charging and normal charging, which is charging using an AC current, of the in-vehicle battery, and
wherein the controller is configured to select the normal charging based on the rainfall information, which indicates that water falls, acquired by the rainfall information acquiring unit.

3. The charging system of the in-vehicle battery according to claim 2, wherein the controller is configured to acquire a state of charge of the in-vehicle battery and to predict, based on the acquired state of charge, a charging end time when the normal charging is selected, and
wherein the controller is configured to select the normal charging under a condition that the predicted charging end time is equal to or less than a desired charging end time set by a user.

4. The charging system of the in-vehicle battery according to claim 2, wherein the controller is configured to acquire a state of charge of the in-vehicle battery and to predict a charging end time when the normal charging is selected based on the acquired state of charge, and
wherein the controller is configured to perform the quick charging with the reduced amount of charging current under a condition that the predicted charging end time is greater than a desired charging end time set by a user.

5. The charging system of the in-vehicle battery according to claim 1, wherein the rainfall information acquiring unit is a rain sensor mounted on a vehicle and configured to detect whether water falls based on wetting of the vehicle.

6. The charging system of the in-vehicle battery according to claim 1, wherein the rainfall information acquiring unit is configured to acquire weather information of an area in which the external charging device is installed.

7. The charging system of the in-vehicle battery according to claim 1, wherein the quick charging is charging using a DC current.

8. The charging system of the in-vehicle battery according to claim 1, further comprising a charging controller that is connected to the in-vehicle battery via a power supply line,
wherein the controller is an electronic control unit and is configured to control the charging mode by outputting a control command to the charging controller based on the acquired rainfall information.

9. A charging method of an in-vehicle battery configured to charge the in-vehicle battery with an external charging device capable of performing quick charging, the charging method comprising:
causing a rainfall information acquiring unit to acquire rainfall information that is information indicating whether water falls;
causing a controller to control a charging mode of the in-vehicle battery with the external charging device; and
inhibiting the performing of the quick charging or reducing an amount of charging current in the quick charging based on the rainfall information, which indicates that water falls, acquired by the rainfall information acquiring unit at a time of controlling the charging mode.
